(19) United States
(12) Patent Application Publication
(10) Pub. No.: US 2001/0053215 A1
(43) Pub. Date: Dec. 20, 2001

(54) Method of processing the calls addressed to a subscriber of a telephone network, and a telephone network, a control device and a program module therefor

(75) Inventors: Sascha Larger, Stuttgart (DE); Wolfgang Zeller, Steinenbronn (DE); Emmanuel Sutter, Bonn (DE)

Correspondence Address: SUGHRUE, MION, ZINN, MACPEAK & SEAS, PLLC, 2100 Pennsylvnia Avenue, N.W., Washington, DC, 20037-3213, US

(73) Assignee: ALCATEL

(21) Appl. No.: 09/879,134

(22) Filed: Jun. 13, 2001

(30) Foreign Application Priority Data
Jun. 16, 2000 (DE) 100 29 753.6

(51) Int. Cl. H04M 1/64; H04M 3/42

(52) U.S. Cl. 379/211.01; 379/88.19

(57) ABSTRACT

The invention relates to a method of processing the calls addressed to a called subscriber (B) of a telephone network (KN), comprising the steps:

receiving a speech message from a calling subscriber (A),

transmitting to the called subscriber (B) a call information derived from the speech message,

receiving from the called subscriber (B) a message for decision of a further processing of the call,

analysing this message to derive a decision for further processing of the call and

execution of the decision for the further processing.

and also a telephone network (KN), a control device (SCP) and a program module for this purpose.

### BACKGROUND OF THE INVENTION

The invention is based on a priority application DE 100 29 753.6, which is hereby incorporated by reference.

The invention relates to a method of processing the calls addressed to a called subscriber of a telephone network, comprising the following steps performed by the telephone network: a speech message is received from a calling subscriber, a call information derived from the speech message is transmitted to the called subscriber, a message for decision of a further processing of the call is received from the called subscriber, said message is analysed to derive a decision for further processing of the call and execution of the decision for the further processing, a telephone network, a control device and a program module therefor.

In the public telephone network (public switched telephone network, PSTN), additional services are being offered to an increasing extent beyond the conventional service of making communication connections. One category of these services is formed by services that serve to inform the subscriber about the communication connection being set up or already set up, such as for example, the display of the telephone number of the calling subscriber at the position of the called subscriber (calling line identification, CLI). A further category of these services is formed by those services that make possible a convenient and flexible utilization of the telephone network, for example by allocating a standard telephone number by which a subscriber can be reached at given times of day at different locations. Said category of services also includes services that increase in the future and in which the setting up of a connection is controlled with the aid of speech input.

As a result of combining abovementioned services, it is possible to offer services that are similar to the service of a personal secretary. In the case of a service offered recently by various network operators of the telephone network, which is called “personal assistant”, the name of the calling subscriber is stated to the subscriber who has subscribed to this service, for example prior to accepting the call. If he does not wish to accept the call, it is made possible for the calling subscriber to leave a message. As a result of simple speech input of a name, for example of the name of the subscriber who has previously called without success, the connection set-up to said subscriber is initiated.

A further service offered makes it possible for the services subscriber to specify a list of names or telephone numbers for those subscribers that are to receive access to a telephone conference (positive list) or are not to receive access to it (negative list).

Common to said services is the fact that it is made possible for the services subscriber to accept or reject calls on the basis of the disclosed identity of the calling subscriber. A further important criterion for call acceptance is, however, the subject of the call. For this purpose, the calling subscriber would have to be given the opportunity of allowing the called subscriber to receive items of information about the subject of the call prior to the actual call, on the basis of which items of information the called subscriber can then decide whether to accept the call. Such a possibility is not available with current services and devices; the called subscriber either has to accept a call initially and then break it off again if necessary, or he awaits a speech message that the calling subscriber transmits, for example, to an answering machine and then decides on the basis of the content of said speech message whether he wishes to conduct a call with said subscriber.

### SUMMARY OF THE INVENTION

The object of the invention is therefore to provide a convenient method and suitable means for implementing a service for real-time processing of call requests (real-time call handling) which makes it possible for a called subscriber to decide on the processing of a call on the basis of an item of information transmitted by the calling subscriber without the called subscriber having to accept the call beforehand. This is intended to be a network-side method and network-side means so that the existing subscriber devices are adequate for this service.

The basic idea of the invention is that a calling subscriber first transmits an item of information to a services device that is transmitted to the called subscriber. The called subscriber can then decide on the basis of said item of information how said call is to be further processed. If he wishes to accept a call, the connection to the calling subscriber is initiated immediately after communicating the acceptance request. In the event of rejection, a certain, fixed message can be transmitted by the services device to the calling subscriber. In addition, it is possible to make provision that the calling subscriber can be connected to another subscriber.

### BRIEF DESCRIPTION OF THE DRAWINGS

Further embodiments of the invention are to be inferred from the dependent claims and the description below.

The invention is further explained below with the aid of the accompanying drawings:

FIG. 1 shows an example of a telephone network according to the invention having service devices contained therein,

FIG. 2a shows, by way of example, a protocol sequence of a method according to the invention of services control in making a call connection,

FIG. 2b shows a protocol sequence, altered with respect to FIG. 2a, of the method according to the invention in the event of call rejection,

FIG. 2c shows a protocol sequence, altered with respect to FIG. 2a, of the method according to the invention in the event of call transmitting and

FIG. 3 shows a telephone network according to the invention in conjunction with the Internet.

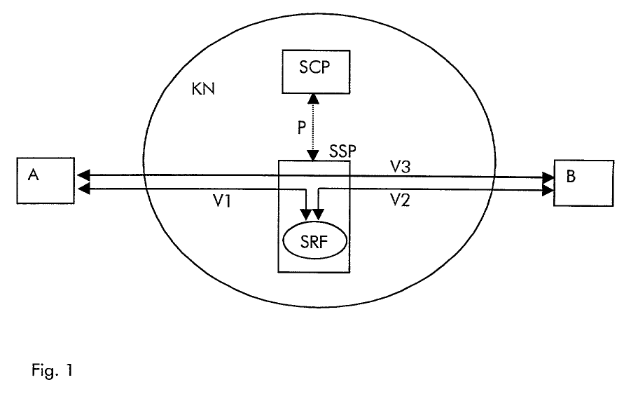

FIG. 1 shows a telephone network (KN) having a (service) switching point SSP and a (service) control point SCP. Shown in the switching point SSP is a function SRF. Furthermore, two subscribers A and B are shown. The term subscriber is understood here as the terminal of the subscriber; however, the term is also used below for the subscribing person himself. In this connection, a connection V1 and V2 is shown in each case between the subscriber A and B, respectively, and the function SRF located in the switching point SSP and a connection V3 routed via the switching point SSP is shown between the subscriber A and the subscriber B. The connections V1, V2 and V3 shown as double arrows are telephone connections. Furthermore, a protocol P for servicess control is shown as a dotted double arrow between the switching point SSP and the control point SCP.

The service described below for real-time processing of call request is shown below as a service of a so-called “intelligent network” (abbreviated to IN). The control point SCP contains means for controlling the services of the intelligent network. The switching point SSP is in this case a switching point that has the so-called service switching function (SSF) built in. The function SRF (specialized resource function) is in this case a special function for speech processing. In this example, it is assumed for the sake of simplicity that the function SRF is built into the switching point SSP. Furthermore, it is assumed for the sake of simplicity that the two subscribers A and B are directly connected to the switching point SSP. As a result, an example of a protocol P for services control can be described below that proceeds selectively between the control point SCP and the switching point SSP. A short overview of the general tasks of the service switching point SSP, the service control point SCP and the specialized resource function SRF in the intelligent network is given in the book entitled “Intelligent Network” by Gerd Sigmund, published in 1999 by the Hüthig Verlag, Heidelberg (ISBN3-7785-3908-6) on page 77.

When subscriber A dials the telephone number of subscriber B, he automatically invokes the service, installed for subscriber B, for the real-time processing of call requests. The switching point SSP detects said call and informs the control point SCP. The control point now causes the switching point SSP to request the subscriber A to transmit an item of information about the requested call. For this purpose, the connection V1 is made between the subscriber A and the function SRF built into the switching point SSP; the internal procedures in the switching point SSP for this purpose are not shown here. The information reception is performed by the function SRF. The control point SCP then initiates the setting up of the connection V2 between the switching point SSP and subscriber B. The function SRF transmits the information transmitted by subscriber A to subscriber B. On the basis of said item of information, subscriber B decides on the further processing of the call requirement of subscriber A. In this connection, there are three basic cases:

a. call acceptance,

b. call rejection and

c. call diversion.

The control point SCP is informed of the choice of subscriber B and, having terminated the connections V1 and V2, sets up, depending on the choice made, a direct connection V3 between subscriber A and subscriber B, the initiation of the connection V2 between the subscriber A and the switching point SSP or the setting up of a connection between subscriber A and a further device not shown here. The specific physical form of the services device is not important for the invention. Thus, it is conceivable to build the function of the control point SCP, the service switching function SSF and the function SRF into one computer. Said functions may also be installed separately in different computers. It is even possible to partition the function SRF in such a way that a simpler functional part is built into the switching point SSP, whereas a more complex functional part, such as, for example, the speech analysis means described below, is built into a separate computer. Furthermore, it is unimportant for the invention whether the subscribers are connected to the same or to different switching points and whether the service switching function SSF is built directly into the switching points or are accommodated in a separate computer. The invention is not limited to the intelligent network, but it could also be implemented by incorporating suitable program modules directly into the switching points mutually connected via the signalling network.

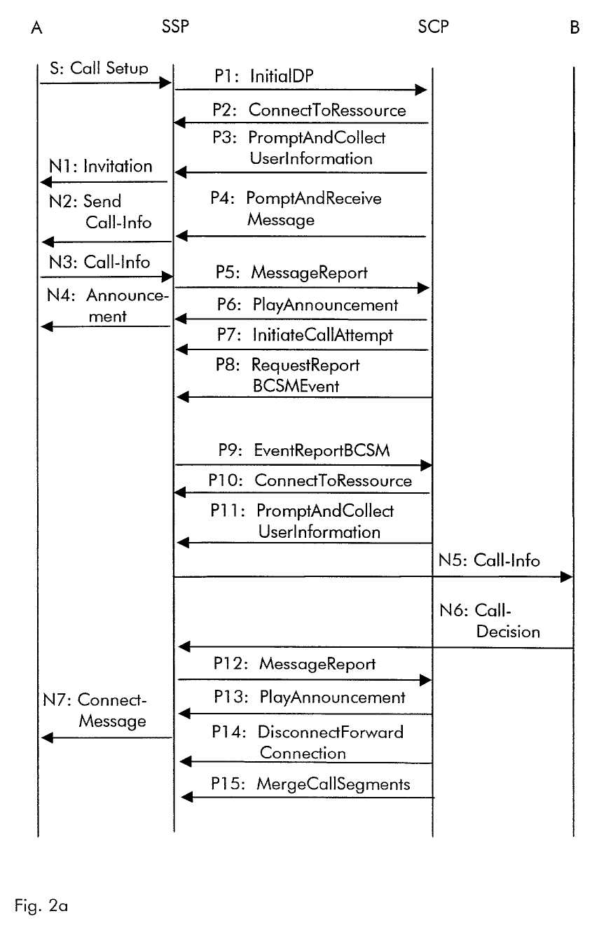

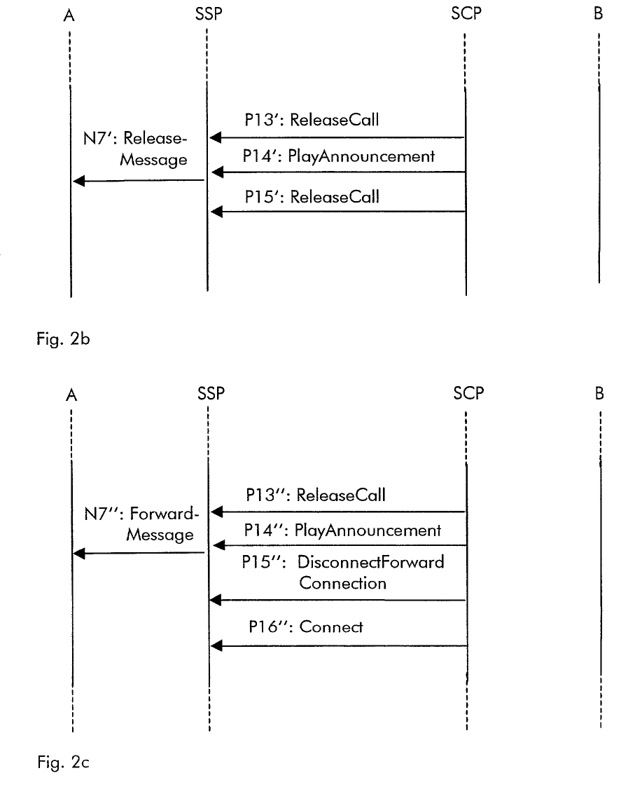

FIGS. 2a -2c describe the protocol P running during the method according to the invention by way of example for each of one of the three abovementioned cases:

FIG. 2a shows an exemplary sequence of the protocol P for the case of call acceptance, the (protocol) messages P1-P5 exchanged between the switching point SSP and the control point SCP being shown in connection with (speech) messages N1-N7 and the message S exchanged between subscribers A and B and the switching point SSP being shown in chronological sequence from top to bottom:

A message S or call setup is sent by subscriber A to switching point SSP,

a message P1 or initialDP is sent by the switching point SSP to the control point SCP,

a message P2 or ConnectToResource is sent by the control point SCP to the switching point SSP,

a message P3 or PromptAndCollectUserInformation is sent by the control point SCP to the switching point SSP,

a message N1 or Invitation is sent by the switching point SSP to subscriber A,

a message P4 or PromptAndReceiveMessage is sent by the control point SCP to the switching point SSP,

a message N2 or Send Call-Info is sent by the switching point SSP to subscriber A,

a message N3 or Call-Info is sent by subscriber A to the switching point SSP,

a message P5 or MessageReport is sent by the switching point SSP to the control point SCP,

a message P6 or PlayAnnouncement is sent by the control point SCP to the switching point SSP,

a message N4 or Announcement is sent by the switching point SSP to subscriber A,

a message P7 or InitiateCallAttempt is sent by the control point SCP to the switching point SSP,

a message P8 or RequestReportBCSMEvent is sent by the control point SCP to the switching point SSP,

a message P9 or EventReportBSCM is sent by the switching point SSP to the control point SCP,

a message P10 or ConnectToResource is sent by the control point SCP to the switching point SSP,

a message P11 or PromptAndCollectUserInformation is sent by the control point SCP to the switching point SSP,

a message N5 or Call-Info is sent by the switching point to subscriber B,

a message N6 or CallDecision is sent by subscriber B to the switching point SSP,

a message P12 or MessageReport is sent by the switching point SSP to the control point SCP,

a message P13 or PlayAnnouncement is sent by the control point SCP to the switching point SSP,

a message N7 or Connect-Message is sent by the switching point SSP to subscriber A,

a message P14 or DisconnectForwardConnection is sent by the control point SCP to the switching point SSP and

a message P15 or MergeCallSegments is sent by the control point SCP to the switching point SSP.

With the message S or Call-Setup, subscriber A transmits the services telephone number of subscriber B. The switching point SSP recognizes the services call on the basis of the services telephone number and informs the control point SCP by means of the message PI or InitialDP. This message starts the services control in the control point SCP. The message P2 or ConnectToResource requests the switching point SSP to make a connection from subscriber A to the function SRF described in FIG. 1. Said function SRF has access to defined speech messages that can be sent in conjunction with said service to subscribers A and B. The message P3 or PromptAndCollectUserInformation requests the switching point to forward a certain speech message, the message Ni or Invitation, to subscriber A. Said message welcomes the subscriber and informs him of the service. In this connection, subscriber A may be provided with the option of entering an identification number in order to achieve a direct connection to subscriber B. After verification of the identification number in the control point SCP, the messages P4-P13 are skipped. The message P4 or PromptAndReceiveMessage requests the switching point SSP to forward a message N2 or Send Call-Info to subscriber A in order to request subscriber A to forward a message N3 or Call-Info. Said message may be a freely formulated item of call information; it is, however, also possible to request subscriber A to forward certain items of information (for example, subject of call, planned call duration and priority) and to forward said information in a certain manner (for example in key words). In order to communicate the end of the transmitting of message N3 to the switching point SSP, provision can be made that subscriber A transmits a certain numeral. A fairly long speech pause by subscriber A may be accepted as the end of the message 3 as an alternative to this end identification, or a fixed, limited time may be provided for transmitting said message. The message P5 or MessageReport informs the control point SCP of the termination of the call reception. The message P6 or PlayAnnouncement requests the switching point SSP to inform subscriber A by means of a message N4 or Announcement that his call request is now being processed. The message P7 or InitiateCallAttempt requests the switching point SSP to make a connection to subscriber B. The message P8 or RequestReportBCSMEvent requests the switching point SSP to inform the control point SCP about the status of the connection making. The switching point SSP informs the control point SCP by means of the message P9 or EventReportBCSM, in particular, about whether subscriber B is available or busy. Various alternatives can be provided for the case where subscriber B is busy. One possibility is that subscriber A is given the option of waiting until subscriber B is available again. This may, for example, be with a message not shown here: “Subscriber B is at present busy; please be patient”. Further alternatives are branchings to the call termination or call forwarding steps described under FIG. 2b or FIG. 2c. If subscriber A is not busy, the message P10 or ConnectToResource requests the switching point SSP to make a connection from subscriber B to the function SRF. The message P11 or PromptAndCollectUserInformation further requests the switching point SSP to transmit to subscriber B the call information transmitted by subscriber A by means of the message N4 and stored in the function SRF by means of the message N5 or Call-Info. Here subscriber B has the said three different options (case a-case c) for the further processing of the call request mentioned under FIG. 1. He communicates his decision by means of the message N6 or Call-Decision. This can be done by inputting a certain numeral. Said decision is analysed in the function SRF and the result is communicated to the control point SCP by means of the message P12 or MessageReport. For the case b, where he does not wish to accept the call, or for the case c where he wishes to forward the call, the control point continues with the steps described under FIG. 2b or 2c, respectively. For the case a, where he wishes to accept the call, the control point SCP requests the switching point SSP by means of the message P13 or PlayAnnouncement to inform subscriber A by means of the message N7 or Connect-Message about the making of the connection to subscriber B, for example: “You are now connected to your desired call party”. The message P14 or DisconnectForwardConnection and the message P15 or MergeCallSegments requests the switching point SSP to terminate the respective connections of subscribers A and B to the function SRF and to connect said subscribers together.

FIG. 2b shows an excerpt of the protocol sequence, which has been altered with respect to FIG. 2a, for the case of call rejection, in which the messages P13-P15 and N7 are replaced by the messages P13′-P15′ and N7′. The excerpt shows only the replaced messages in chronological sequence:

A message P13′ or ReleaseCall is sent by the control point SCP to the switching point SSP, a message P14′ or PlayAnnouncement is sent by the control point SCP to the switching point SSP and a message N7′ or Release-Message is sent by the switching point SSP to subscriber A and a message P15′ or ReleaseCall is sent by the control point SCP to the switching point SSP.

In this protocol sequence, those steps are shown that are traversed if subscriber B has decided on call rejection by means of the message N6 or CallDecision described in FIG. 2a. After the control point SCP receives said decision by means of the message P12, it now transmits the message P13′ or ReleaseCall. This requests the switching point SSP to clear the connection to the called subscriber B. The message P14′ or PlayAnnouncement furthermore requests the switching point SSP to inform subscriber A by means of the message N7′ or ReleaseMessage that his call request has not been accepted. The message P15′ or ReleaseCall then clears the connection to subscriber A. FIG. 2c shows an excerpt from the protocol sequence, altered with respect to FIG. 2a, for the call diversion case, in which the messages P13-P15 and N7 are replaced by the messages P13″-P16″ and N7″. The excerpt shows only the replaced messages in chronological sequence: A message P13″ or ReleaseCall is sent by the control point SCP to the switching point SSP, a message P14″ or PlayAnnouncement is sent by the control point SCP to the switching point SSP and a message N7″ or ForwardMessage is sent by the switching point SSP to subscriber A, a message P15′ or DisconnectForwardConnection and a message P16′ or Connect is sent by the control point SCP to the switching point SSP.

In this protocol sequence, those steps are shown that are traversed if subscriber B has decided on call forwarding with the message N6 or Call-Decision described in FIG. 2a. After the control point SCP receives said decision by means of message P12, it then transmits the message P13″ or ReleaseCall. This requests the switching point SSP to initiate the connection to the called subscriber B. The message P14″ or PlayAnnouncement further requests the switching point SSP to inform subscriber A by means of the message N7″ or ForwardMessage that he is to be connected to another device, for example a further subscriber C not shown here. The message P15″ or DisconnectForwardConnection and the subsequent message P16″ or Connect requests the switching point SSP to terminate the connection of subscriber A to the function SRF described under FIG. 2a and to make a connection to another device.

For the sake of clarity, no further signalling messages except the message S are shown in FIGS. 2a-2c between subscribers A and B and the switching point SSP, such as, for example, the standard messages “Setup” or “Connect” prior to setting up a connection and the standard message “Release” for clearing a connection. For the person skilled in the art, it is readily possible to complete the abovedescribed protocol sequences with said messages. The messages exchanged between the switching point SSP and the control point SCP are based on the so-called “intelligent network application protocol” (INAP) defined by the ITU-T.

An advantageous development of the abovedescribed method is for the function SRF to contain speech analysis means. The decision of subscriber B can thereby take place, for example, by transmitting certain speech messages, for example “Put through”, “Reject” or “Forward”, instead of by inputting a certain numeral. This is particularly advantageous if a plurality of alternatives are provided for forwarding, for example to various employees of a company. In addition, the message N3 transmitted by subscriber A can be analysed for a certain content. Subscriber B could desire, for example, that only call requests having a certain subject are put through. For this purpose, he specifies to the services device predetermined key words. The function SRF analyses the message N3 transmitted by subscriber A to determine whether said key words are present. If a key word is present, an immediate connection can be made between subscriber A and subscriber B, for example, to shorten the waiting time. Alternatively, provision can be made that, although the services sequence is not altered, only the key words present are transmitted as message N4 instead of the entire message N3 transmitted by subscriber A.

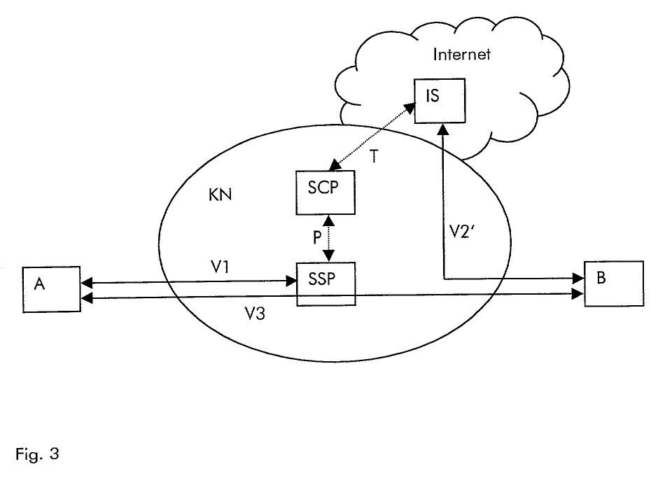

FIG. 3 shows the telephone network KN disclosed in FIG. 1 with the switching point SSP and the control point SCP. Subscribers A and B are furthermore shown. In addition to FIG. 1, a network symbolizing the Internet and having a computer IS is shown here in addition to the telephone network KN. As in FIG. 1, a connection V1 is shown between subscriber A and the switching point SSP and a connection V3 routed via the switching point SSP is shown between subscriber A and subscriber B. As a departure from FIG. 1, however, instead of the connection V2, a communication relationship V2′ is shown between subscriber B and the computer IS. In addition to protocol P between the switching point SSP and the control point SCP, a further protocol T is shown between the control point SCP and the computer IS.

The essential difference from the telephone network described under FIG. 1 is, in this case, that the Internet is included in the abovedescribed service. In this connection, the computer IS is a so-called “web server” that can transmit so-called “web pages”, i.e. written information, in an electronic page format. With the aid of the protocol T, which may be constructed, for example, on the basis of the TCP/IP protocol standard in the Internet, the computer IS is instructed now to transmit the message N5 transmitted in FIG. 1 via the connection V2 in the form of a “web page” to subscriber B. This can take place by a speech-to-text conversion in the function SRF described under FIG. 2a. Subscriber B sends his selection N6 back to the computer IS, which informs the control point SCP in the course of the protocol sequence T. In other respects, the service proceeds analogously to the service described, in particular, under FIGS. 2a -2c. An important advantage of including the Internet is the greater user-friendliness for subscriber B. If he has an ISDN connection with two user channels, he can already receive information about a new call request even during an existing telephone connection. Furthermore, he may be given the option of entering a short message via the Internet, which is then converted to speech in the function SRF and transmitted to subscriber A. It is furthermore possible to transmit both speech messages by means of the so-called “voice over IP” protocol and data by means of TCP/IP via only one channel.

1. Method of processing the calls addressed to a called subscriber of a telephone network, comprising the following steps performed by the telephone network:
a speech message is received from a calling subscriber,
a call information derived from the speech message is transmitted to the called subscriber,
a message for decision of a further processing of the call is received from the called subscriber,
said message is analysed to derive a decision for further processing of the call and
execution of the decision for the further processing.

2. Method according to claim 1, wherein the call information contains an offer of two or more options for further processing of the call.

3. Method according to claim 2, wherein one option consists in establishing a connection between the calling and the called subscriber.

4. Method according to claim 2, wherein one option consists in transmitting a stored message to the calling subscriber.

5. Method according to claim 2, wherein that one option consists in establishing a connection between the calling and a further subscriber.

6. Method according to claim 1, wherein the speech message received from the calling subscriber is analysed for particular speech contents and that the calling subscriber gets connected to the called subscriber if a particular speech content is detected in the message.

7. Method according to claim 1, wherein the speech message received from the calling subscriber is analysed for a certain speech content and the call information transmitted to the called subscriber contains an analysis result.

8. Method according to claim 1, wherein the call information to inform the called subscriber and the message for decision of a further processing of the call are transmitted via the Internet.

9. Telephone network with devices, in particular devices of the intelligent network, for execution of services, with the following means:
means to receive a speech message of a calling subscriber,
means to generate a call information from the speech message and to send this call information to the called subscriber,
means to receive a message for decision of a further processing of the call from the called subscriber,
means to analyse said message to derive a decision for further processing of the call and
means for execution of the further processing according to the derived decision.

10. Control device for controlling services in a telephone network, with means to generate the following commands to be sent to a service switching device:
command to initiate the reception of a speech message of a calling subscriber,
command to initiate the transmission of call information to the called subscriber to decide on the further processing of the call,
command to return a report of a received message from the called subscriber and
command to initiate the processing of the call according to a decision, derived by analysis of said report.

11. Program module for execution in a control device of a telephone network, with means to control the transmission of the following commands to a service switching devide:
command for reception of a speech message of a calling subscriber,
command to transmit call information to the called subscriber for decision on the further processing of the call,
command to return a report of a received message from the called subscriber and
command to initiate the processing of the call according to a decision, derived by analysis of said report.
